(19) United States
(12) Patent Application Publication
(10) Pub. No.: US 2011/0154814 A1
(43) Pub. Date: Jun. 30, 2011

(54) PNEUMATIC ACTUATOR AND ELECTRICAL SWITCH SYSTEM

(76) Inventor: Graham J. Campbell, Stevenson Ranch, CA (US)

(21) Appl. No.: 12/980,981

(22) Filed: Dec. 29, 2010

Related U.S. Application Data
(60) Provisional application No. 61/291,671, filed on Dec. 31, 2009.

(51) Int. Cl. F15B 13/00

(52) U.S. Cl. 60/407

(57) ABSTRACT

An exemplary embodiment of a pneumatic actuator assembly includes a hollow body member, and a transverse nipple member including a flange portion, and a hollow passageway leading to a hollow nipple portion. A bellows member is positioned in the body member and is configured to receive the flange portion of the nipple member at an open end. A button member disposed at the closed end of the bellows member and arranged to slide within a range of movement within the body member to compress the bellows and actuate the assembly. The nipple portion of the nipple member is arranged transversely with respect to the longitudinal axis of the body member and configured for connection to a hollow tubing end.

### CROSS-REFERENCE TO RELATED APPLICATION

This application claims the benefit of U.S. Provisional Application No. 61/291,671 filed Dec. 31, 2009, the entire contents of which are hereby incorporated by reference.

### BACKGROUND

Air or pneumatic switch systems are typically used in environments subject to wet conditions, to control electrical equipment without exposing the user to electrical shock hazards. The systems employ a pneumatic actuator, connected to a receiver device by a sealed air conduit. The user can press a button on the actuator, which compresses the air in the sealed conduit. The compression is sensed by the receiver device, and the received device performs electrical switching in response to the sensing.

Problems can be encountered in installing the actuators in surfaces with limited clearance space. For example, the air switches are sometimes used in bathing installations such as whirlpool baths or spas, and preferred locations for installation of the actuator may be on surfaces of the tub of the bathing installation. Clearance space behind the exposed surface is typically limited. Conventional actuators employ a nipple to connect to tubing which exits 180 degrees from the top, i.e. aligned with the center axis of the actuator. The tubing then protrudes a distance from the bottom of the actuator. This arrangement provides no protection for the exposed nipple, which can be impacted and broken off. Moreover, the tubing can be knocked off in installation, e.g. the tubing can get caught on a stud or board when being dropped into place, and pulled away from the nipple. This is particularly a problem when the actuator is pre-installed on a bathing installation tub at the factory, and the tub is later installed on-site. While the operating button of the actuator is visible from the exposed surface of the tub, the back-side of the actuator with attached tubing will not be readily visible to the installer. The actuator can readily be damaged by striking a support such as a stud or board, particularly with the weight of the tub adding to the force applied during installation.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a diagrammatic isometric view of an exemplary embodiment of a pneumatic switch system for controlling an electrically power device or system, including a pneumatic actuator assembly.

FIG. 2A is an isometric bottom view of the actuator assembly of the system of FIG. 1.

FIG. 2B is an isometric bottom view similar to FIG. 2A, but with a tube attached to the output port of the actuator assembly for connection to a receiver switch.

FIG. 3 is a top view of the actuator assembly of FIG. 1.

FIG. 4 is a cross-sectional view of the actuator assembly, taken through line 4-4 of FIG. 3.

FIG. 5 is a cross-sectional view of the actuator assembly, taken through line 5-5 of FIG. 3.

FIG. 6 is a bottom view of the actuator assembly of FIG. 2B.

FIG. 7 is an exploded view of the actuator assembly of FIG. 1.

FIGS. 8A and 8B are respective top and bottom isometric views of an alternate embodiment of a pneumatic actuator assembly. FIG. 8C is a side view of the actuator assembly of FIGS. 8A and 8B.

FIG. 9 is a top view of the actuator assembly of FIGS. 8A-8C.

FIG. 10 is a cross-sectional view taken through line 10-10 of FIG. 9.

FIG. 11 is an exploded view of the actuator assembly of FIGS. 8A-8C.

### DETAILED DESCRIPTION

In the following detailed description and in the several figures of the drawing, like elements are identified with like reference numerals. The figures are not to scale, and relative feature sizes may be exaggerated for illustrative purposes.

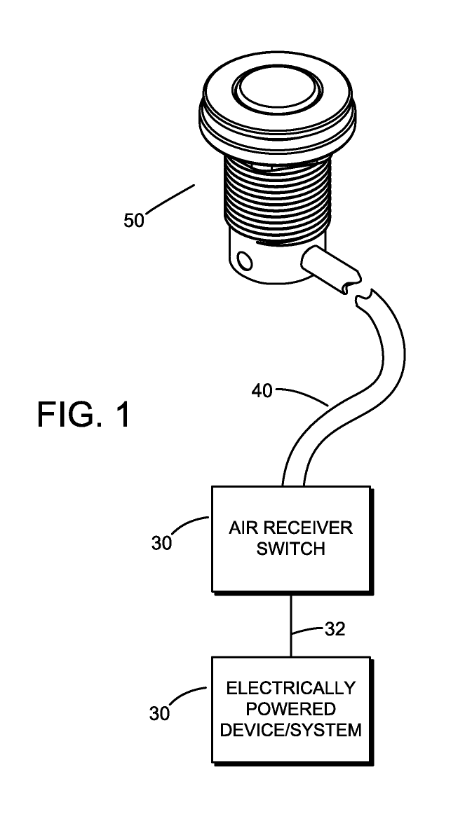

An exemplary embodiment of a pneumatic actuator assembly 50 is depicted in FIG. 1. The actuator assembly is connected to a receiver switch 30 by a flexible hollow tube 40 to provide a sealed air conduit between the actuator and the receiver switch. The receiver switch 30 is conventional, and there are different receiver switches readily available in the marketplace. The receiver switch 30 is connected to an electrical device or system 20 by an electrical line or cabling 32, and may be used to control operation of the device or system 20, e.g. by turning the device on or off, or to otherwise provide a control signal to the device or system 20. For a bathing installation application, the device or system 20 may be, for example, a pump, blower, light or other device associated with the bathing installation. For a kitchen application, the device or system 20 may be a garbage disposal, for example. The actuator assembly 50 may be employed in other applications to control or operate other devices as well.

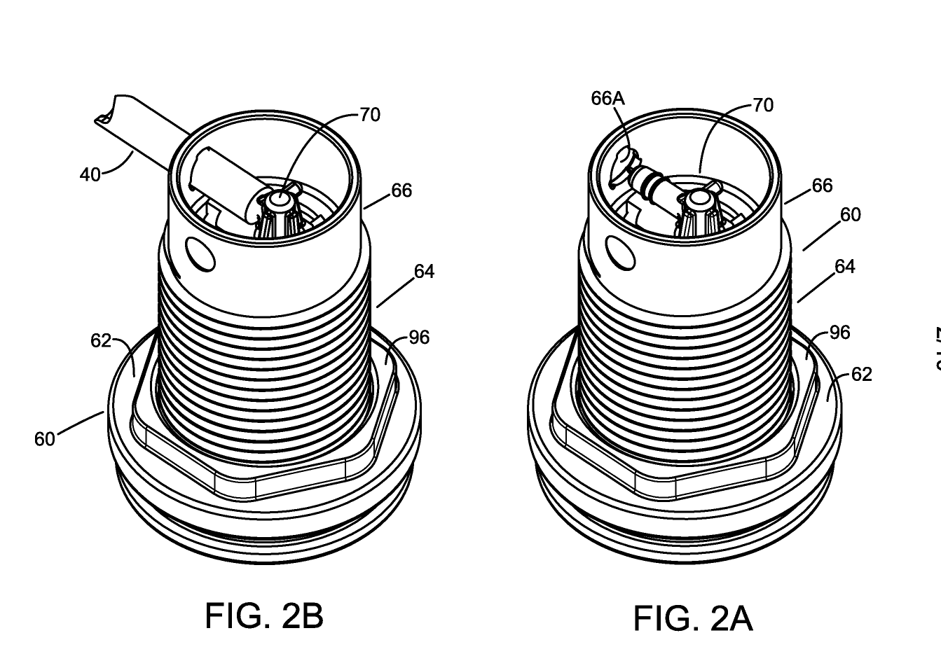

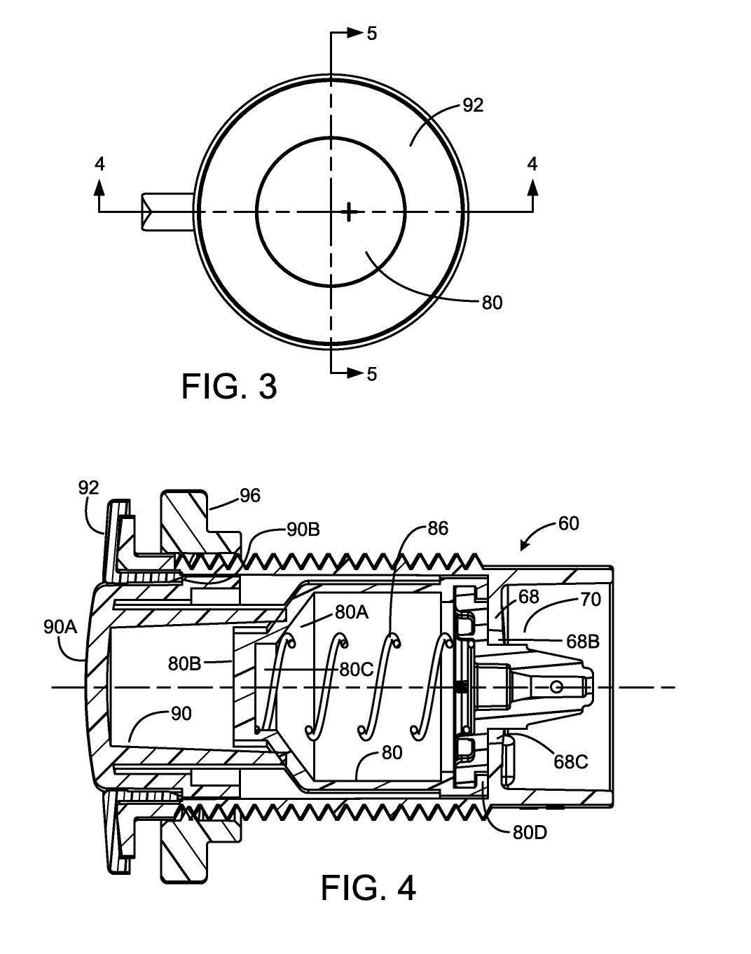

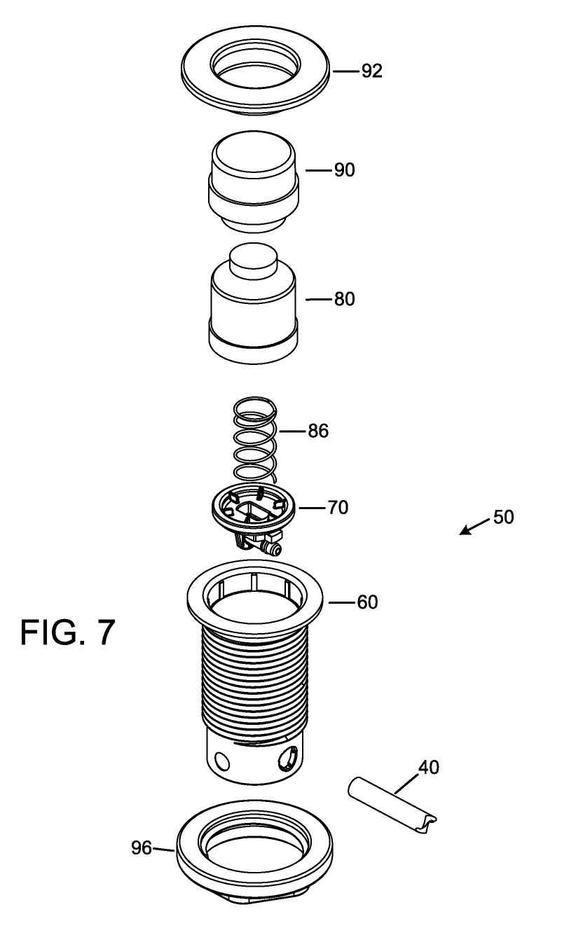

An exemplary embodiment of the actuator assembly 50 is illustrated in further detail in FIGS. 2-7. The assembly includes a hollow body member 60 having a generally cylindrical outer configuration, with a flange 62 formed at one end, an intermediate threaded exterior portion 64, and a skirt portion 66 extending from the threaded portion. A hole or opening 66A is formed in the skirt portion, providing an entry portal through the skirt portion for insertion of the tube 40. The body member 60 further includes a transverse bottom wall portion 68 formed across the interior of the body portion at a junction between the threaded portion and the skirt portion. The bottom wall portion 68A has an opening formed therein to receive a 90 degree nipple member 70. The opening 68A is generally circular, with opposed windows 68B and 68C extending out from the periphery of the circle configuration, to facilitate assembly of the nipple member to the body member.

In an exemplary embodiment, the body member 60 is a unitary injection-molded part, made from a plastic material such as ABS.

The assembly 50 further comprises the 90 degree nipple member 70, a bellows member 80, a bias member 86 disposed inside the bellows to bias the bellows to an extended position, a cup-like button member 90 and an escutcheon 92. A threaded nut 96 is provided to secure the body member in place after the body member has been inserted through an opening in a mounting wall or surface, with the flange portion 62 larger than the wall opening.

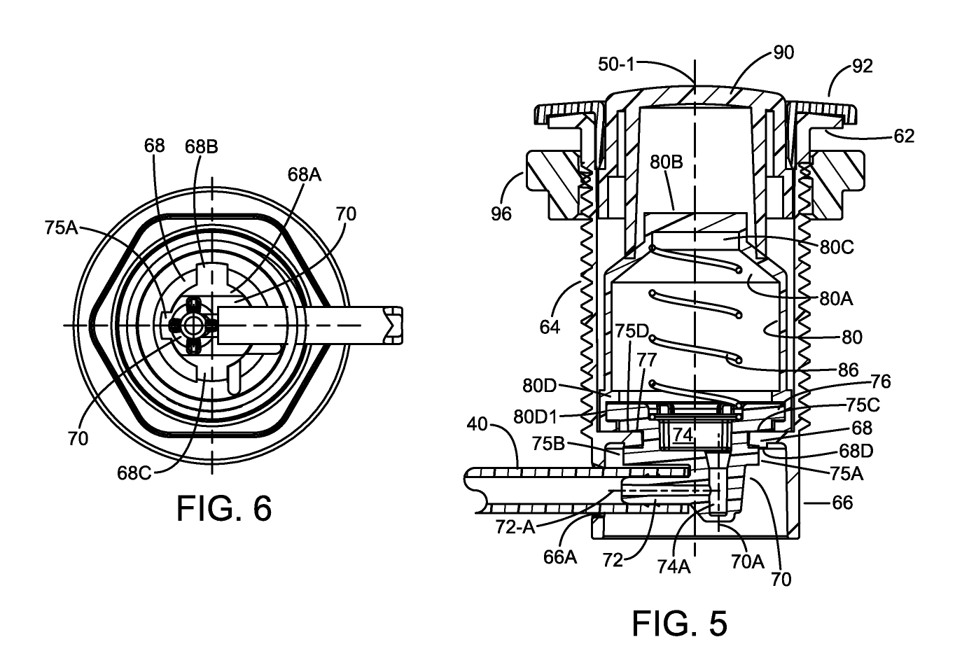

In an exemplary embodiment, the bellows 80 is an inverted cup-like member with an interior volume, and may be fabricated of an elastomeric material, e.g. rubber, to allow the bellows to be compressed to reduce the size of the interior volume. As illustrated in FIGS. 4 and 5, for example, the exterior diameter of the bellows 80 is slightly smaller than the interior diameter of the body member 60. The top closed wall portion 80A of the bellows tapers to a generally flat end portion 80B, to define a recess 80C sized to receive an end of the bias member 86, which is a spring in this embodiment. In other embodiments, the spring may be molded into the bellows, or omitted as a separate bias structure if the bellows is formed of a material with sufficient memory to restore to the extended position after being compressed by a button push.

The open end of the bellows 80 is fabricated with a double flange portion 80D. The flange portion is sized to allow the nipple member 70 to be inserted into the flange portion for assembly. The bellows in this embodiment is elastic, allowing the bottom lip of the flange portion to be manipulated open to insert the nipple member. The bellows, spring and nipple member can thus be assembled together to form a sub-assembly, for insertion into the body member 60.

The nipple member 70, e.g. as shown in FIGS. 4-6, is a unitary member fabricated of injection-molded plastic, e.g. ABS. The nipple member defines an interior plenum region 74 in fluid communication with a passageway 74A leading to a transverse, hollow, 90 degree nipple portion 72. In this embodiment, the passageway 74A has an axis 70-A which is offset from the center axis 50-1 of the actuator assembly 50. At the opposite end of the nipple member from the nipple 72, a flange 76 is defined, and is sized for fitting into the channel 80D1 defined by the double flange portion 80D of the bellows. When the flange 76 of the nipple is fitted into the corresponding flange portion of the bellows, a gas seal is formed between the periphery of the flange 76 and the bellows. The open interior volume of the bellows is then in communication with the plenum 74 of the nipple member 70.

The nipple member 70 further has opposed locking tabs or ears 75A, 75B (FIG. 5) spaced from the flange portion 76 to form open channels regions 75C, 75D. The locking tabs and the open channel regions are sized in cooperation with corresponding dimensions of the bottom wall 68, and the opening 68A, and open windows 68B, 68C, to allow the assembly of the sub-assembly of the bellows-spring-nipple member to the body member 60. Particularly, the sub-assembly can be inserted into the body member 60 at the flange end of the body member, with the nipple member oriented so that the locking tabs 75A, 75B are aligned with the open windows 68B, 68C of the opening 68A in the bottom wall 68 of the body member in an insertion orientation. With the axis of the passageway 74A offset from the center axis of the body member, the nipple 72 and the locking tabs 75A, 75B can be inserted through the opening 68A until the bottom surfaces of the bellows 80 at the flange portion 80D and shoulder region 77 of the nipple member contacts the bottom wall 68. Then the sub-assembly is rotated 90 degrees relative to the body member in an assembly orientation, so that the locking tabs are brought into contact with the underside of the bottom wall and ramp regions 68D of slightly increasing thickness, with the flange portions of the bellows being compressed against the bottom wall 68, thereby locking the nipple member in place and providing a fluid seal.

The skirt portion 66 of the body member in this embodiment is elongated, so that its distal end extends beyond the tip of the nipple member in the assembled orientation. The skirt portion provides a protective shield, preventing damage to the nipple, and the tube attached to the nipple. With the nipple member in the assembled orientation, the axis 72-A of the nipple 72 will be substantially aligned with an opening 66A formed in the skirt portion 66 of the body member 60. The end of the tube 40 can be inserted through the opening 66A and pushed onto the nipple 72 to provide a press-fit seal. To provide a stress relief clamp, the opening 66A is defined by chamfering the wall of the skirt portion, so that the diameter of the opening at the exterior surface of the wall is slightly larger than the outer diameter of the tubing, and the diameter of the opening at the interior surface of the wall is slightly smaller than the outer diameter of the tubing. This forms “Chinese” fingers at the opening which allow the tube to be inserted into the opening to press onto the nipple, but then resist pulling the tube out away from the nipple and out the opening.

With the sub-assembly of the nipple-bellows-bias member assembled to the body member 60, the button member 90 may be inserted into the body member, until the distal edge of the button member contacts the bellows member, e.g. as shown in FIG. 4. The outer diameter of the button member is slightly smaller than the inner diameter of the body member at the flange end. In this embodiment, the diameter of the region 80B of the bellows is smaller than the inner diameter of the button member, and is received within the open region within the button member. Thus, by pressing on the top 90A of the button member, the user can apply pressure on the bellow to compress the bellows, thus compressing the air within the bellows and the plenum 74 of the nipple member 70. To retain the button member within the body member, an escutcheon 92 is press-fit into the body member at the flange end. The button member has a somewhat reduced diameter at its upper end, to form a shoulder 90B. When the escutcheon is press-fitted into the body member, the escutcheon distal end contacts the shoulder 90B, fixing the upper end of travel of the button member within the body region.

The actuator assembly 50 may be connected by the tubing 40 to the receiver 30, as shown in FIG. 1, providing a closed air conduit between the bellows member and the receiver. The receiver typically includes a pressure sensitive transducer, responsive to the user pressing the button member 90 to compress the air volume within the bellows and increase the pressure in the closed conduit, to actuate an electrical switch in the receiver. The switch may then control operation of the device 20, e.g. in the bathing installation example, a pump operating on line voltage, or a light operating on low voltage.

The embodiment of the actuator assembly illustrated in FIGS. 1-7 provides a number of advantages over conventional actuators, including the following:

a. The actuator may have a shorter overall length due to the tube not exiting 180 degrees from the top of the button, thus permitting the actuator to be used in tighter spaces.

b. The actuator does not have unprotected protruding tubing, to be knocked off in installation of a bathing installation tub.

c. Built in strain relief is provided by the hole in the outer skirt portion or sheath (as the tubing is pushed through the hole to be installed on the right angle nipple, strain relief is formed).

d. The sheath around the nipple protects against damage.

e. A shorter length of tubing can be used to connect to the receiver, as the actuator can be positioned with the nipple oriented in the direction of the pump or device to which it is being connected (typically the received may be installed on the pump or device).

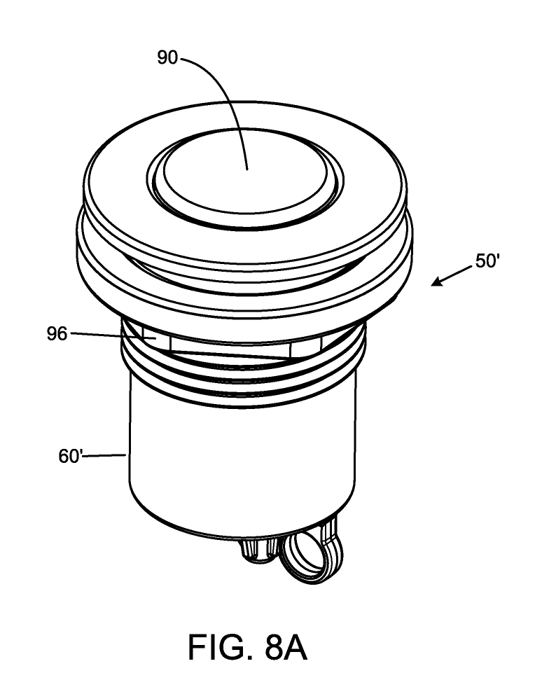

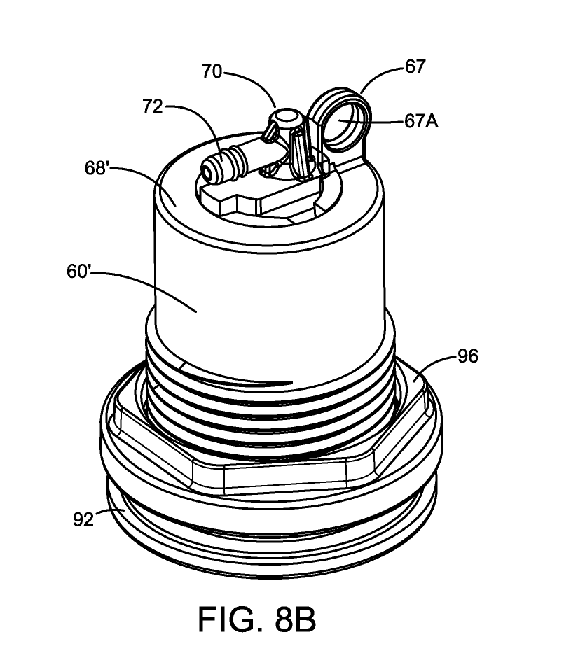

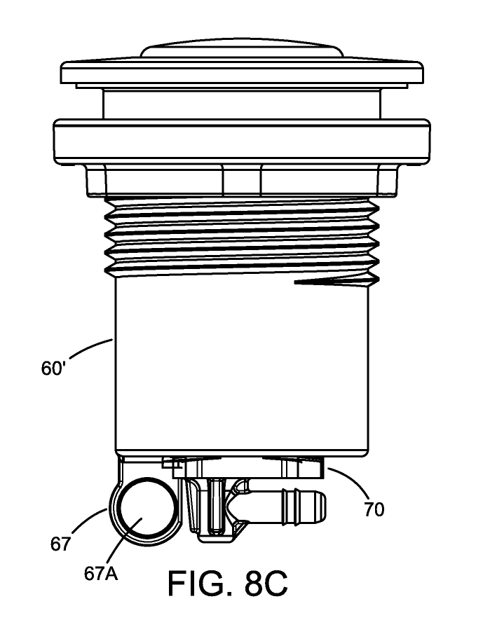

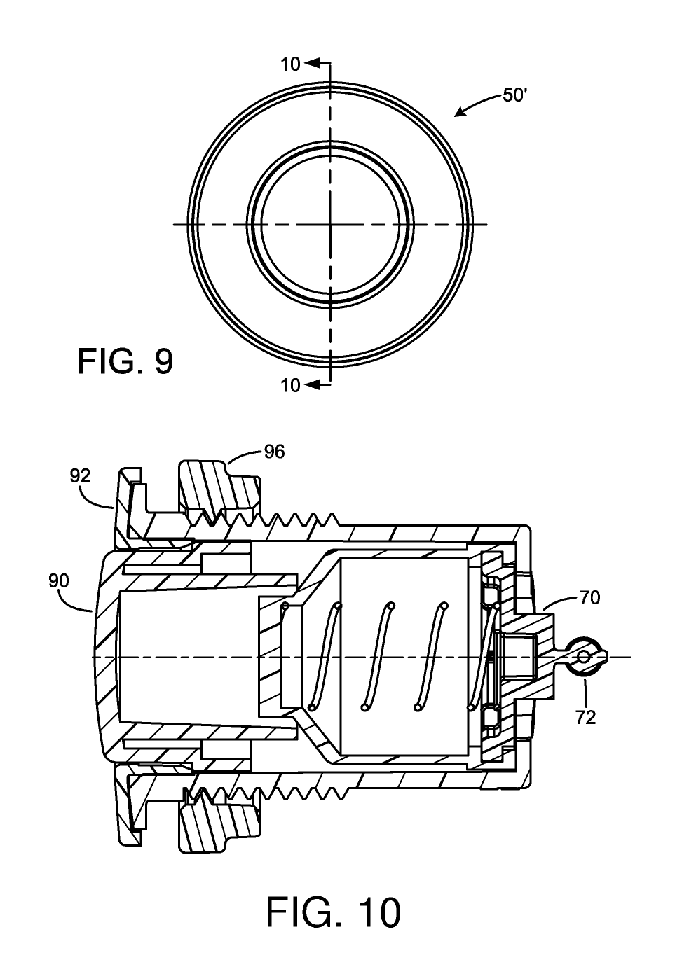

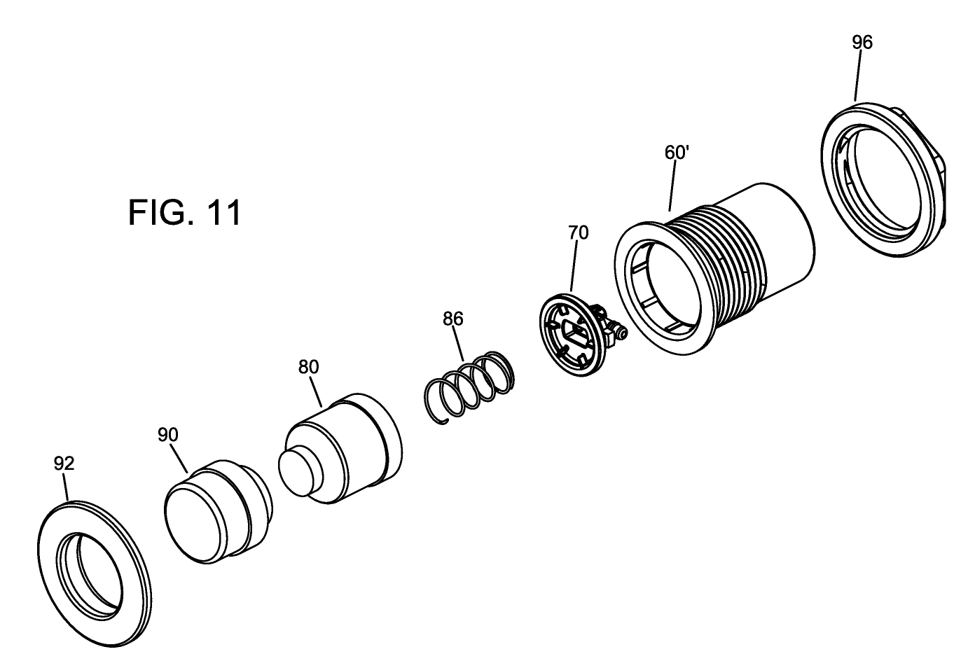

An alternate embodiment of an actuator assembly 50′ is illustrated in FIGS. 8A-11. The alternate embodiment differs from the embodiment of FIGS. 1-7 in several respects. The nipple member, bellows, bias member, nut button member and escutcheon elements are all similar to those described above regarding the assembly 50 (FIGS. 1-7), and the same reference numbers refer to the corresponding parts. The body member 60′ of the alternate embodiment 50′ differs from the body member 60 in the following respects.

The body member 60′ does not include the skirt or shield portion 66 of the body member 60. The body member 60′ terminates at bottom wall 68′, with the right angle nipple region of the nipple member 70 protruding from the opening in the bottom wall 68′. This allows the actuator assembly 50′ to have a reduced overall length relative to the embodiment of FIGS. 1-7, although the protective skirt or shield is not provided in this embodiment. An optional feature which may be included in the body member 60′ is the protruding boss 67, formed with an open loop 67A opposite the terminal end of the right angle nipple 72. The tubing 40 may be inserted through the open loop and passed around to the nipple to be fitted onto the nipple. The boss and open loop may then provide some strain relief to the tubing.

Although the foregoing has been a description and illustration of specific embodiments of the invention, various modifications and changes thereto can be made by persons skilled in the art without departing from the scope and spirit of the invention.

What is claimed is:

1. A pneumatic actuator assembly, comprising:
a hollow body member having a generally cylindrical outer configuration along a longitudinal axis, with a flange formed at or adjacent one end, and a threaded exterior portion;
the body member further including a transverse bottom wall portion formed across the interior of the body portion, the bottom wall portion having an opening formed therein to receive a transverse nipple member;
the nipple member a unitary structure including a flange portion, an interior plenum region in fluid communication with a passageway leading to a hollow nipple portion;
a bellows member with an interior volume, a closed end and an open end, and fabricated of a material allowing the bellows to be compressed to reduce the size of the interior volume, the bellows member configured to receive the flange portion of the nipple member at the open end to close the bellows opening;
a bias member to bias the bellows to an extended position;
a button member disposed at the closed end of the bellows member and arranged to slide within a range of movement within the body member to compress the bellows and actuate the assembly;
a threaded nut to secure the body member in place after the body member has been inserted through an opening in a mounting wall or surface, with the flange portion larger than the wall opening; and
wherein the nipple portion is arranged transversely with respect to the longitudinal axis of the body member, the nipple member configured for connection to a hollow tubing end.

2. The assembly of claim 1, wherein the nipple portion of the nipple member extends at about 90 degrees relative to the longitudinal axis of the body member.

3. The assembly of claim 1, wherein the nipple member further comprises a loop portion having a loop opening through which the tubing member is inserted to provide strain relief.

4. The assembly of claim 1, wherein the body member further includes a sheath or skirt portion extending from the threaded portion, and a hole or opening is formed in the skirt portion, providing an entry portal through the skirt portion for insertion of a tube, the nipple member disposed within a periphery of the skirt portion.

5. The assembly of claim 4, wherein the opening in the skirt portion is defined by chamfering the wall of the skirt portion, so that the diameter of the opening at an exterior surface of the wall is slightly larger than an outer diameter of the tubing, and the diameter of the opening at an interior surface of the wall is slightly smaller than the outer diameter of the tubing, allowing the tubing to be inserted into the opening to press onto the nipple, but then resist pulling the tube out away from the nipple and out the opening.

6. The assembly of claim 1, wherein the body member is a unitary injection-molded part, made from a plastic material.

7. The assembly of claim 1, wherein the passageway of the nipple member includes a portion generally parallel to and offset from the longitudinal axis of the body member.

8. A pneumatic actuator assembly, comprising:
a hollow body member having an elongated interior opening along a longitudinal axis, a flange portion and a threaded exterior portion;
the body member further including a transverse bottom wall portion formed across the interior of the body portion, the bottom wall portion having an opening formed therein to receive a transverse nipple member;
the nipple member comprising a unitary structure including a flange portion, and a hollow passageway leading to a hollow nipple portion;
a bellows member with an interior volume, a closed end and an open end, and fabricated of a material allowing the bellows to be compressed to reduce the size of the interior volume, the bellows member configured to receive the flange portion of the nipple member at the open end to close the bellows opening;
a bias structure to bias the bellows to an extended position;
a button member disposed at the closed end of the bellows member and arranged to slide within a range of movement within the body member to compress the bellows and actuate the assembly;
a threaded nut to secure the body member in place after the body member has been inserted through an opening in a mounting wall or surface, with the flange portion larger than the wall opening; and
wherein the nipple portion is arranged transversely with respect to the longitudinal axis of the body member, the nipple member configured for connection to a hollow tubing end.

9. The assembly of claim 8, wherein the nipple portion of the nipple member extends at about 90 degrees relative to the longitudinal axis of the body member.

10. The assembly of claim 8, wherein the nipple member further comprises a loop portion having a loop opening through which the tubing member is inserted to provide strain relief.

11. The assembly of claim 8, wherein the body member further includes a sheath or skirt portion extending from the threaded portion, and a hole or opening is formed in the skirt portion, providing an entry portal through the skirt portion for insertion of the hollow tube, the nipple member disposed within a periphery of the skirt portion.

12. The assembly of claim 11, wherein the opening in the skirt portion is defined by chamfering the wall of the skirt portion, so that the diameter of the opening at an exterior surface of the wall is slightly larger than an outer diameter of the tubing, and the diameter of the opening at an interior surface of the wall is slightly smaller than the outer diameter of the tubing, allowing the tubing to be inserted into the opening to press onto the nipple, but then resist pulling the tube out away from the nipple and out the opening.

13. The assembly of claim 8, wherein the body member is a unitary injection-molded part, made from a plastic material.

14. The assembly of claim 8, wherein the passageway of the nipple member includes a portion generally parallel to and offset from the longitudinal axis of the body member.
